(19) United States
(12) Patent Application Publication
(10) Pub. No.: US 2006/0081335 A1
(43) Pub. Date: Apr. 20, 2006

(54) Semiconductor substrate processing apparatus and semiconductor device fabrication method

(76) Inventors: Hiroyasu Iimori, Yokohama-Shi (JP); Hiroshi Tomita, Yokohama-Shi (JP); Hiroaki Yamada, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/246,140

(22) Filed: Oct. 11, 2005

(30) Foreign Application Priority Data
Oct. 13, 2004 (JP) 2004-298540

(51) Int. Cl. C23F 1/00; C03C 15/00

(52) U.S. Cl. 156/345.15; 216/84

(57) ABSTRACT

According to the present invention, there is provided a semiconductor substrate processing apparatus comprising: a processing bath which etches a semiconductor substrate by dipping the semiconductor substrate into a processing solution; an outer bath which is positioned outside said processing bath and receives the processing solution overflowing from said processing bath; a circulation channel which resupplies the processing solution discharged from said outer bath to said processing bath; a heater which adjusts a temperature of the processing solution flowing through said circulation channel; a filter which removes foreign matter in the processing solution flowing through said circulation channel; and a controller which measures, after the semiconductor substrate is loaded into said processing bath, one of the temperature of the processing solution in said processing bath and a time during which the temperature of the processing solution restores a predetermined temperature, calculates a processing time during which the semiconductor substrate is etched on the basis of the measurement result, and etches the semiconductor substrate on the basis of the calculated processing time.

### CROSS REFERENCE TO RELATED APPLICATION

This application is based upon and claims benefit of priority under 35 USC §119 from the Japanese Patent Application No. 2004-298540, filed on Oct. 13, 2004, the entire contents of which are incorporated herein by reference.

### BACKGROUND OF THE INVENTION

The present invention relates to a semiconductor substrate processing apparatus and semiconductor device fabrication method.

There is a semiconductor substrate processing apparatus which etches or cleans a semiconductor substrate by dipping it in a processing solution in a processing bath.

Outside the processing bath containing the processing solution, this semiconductor substrate processing apparatus has an outer bath for receiving the processing solution overflowing from the processing bath. When discharged from the outer bath, the processing solution is resupplied to the processing bath through a circulation channel.

The circulation channel has a pump for circulating the processing solution, and a heater for adjusting the temperature of the processing solution which flows through the circulation channel.

When etching or cleaning for a semiconductor substrate is repeated in the processing bath, particles and the like come off the semiconductor substrate. If these particles are left unremoved, they may reattach to the semiconductor substrate. Therefore, the circulation channel has a filter for removing particles in the processing solution which flows through the circulation channel, and the particles are captured by this filter.

When the filter is clogged with the air, the circulation flow rate decreases. To prevent the decrease, the filter is connected to a filter air vent line which directly supplies the processing solution to the outer bath, in addition to the circulation channel which supplies the processing solution to the processing bath. When the filter is clogged with the particles, the processing solution is supplied to the outer bath through the filter air vent line at a flow rate corresponding to the decrease.

When a semiconductor substrate is loaded into the processing bath, the temperature of the processing solution falls under the influence of the semiconductor substrate. This temperature fall of the processing solution decreases the etching rate. Therefore, the heater is turned on to restore the temperature of the processing solution to a temperature suitable for etching. If, however, the flow rate in the filter air vent line has increased owing to clogging of the filter, the time for restoring the temperature of the processing solution in the processing bath prolongs.

In this case, no desired etching rate can be obtained. Therefore, etching is not actually completed in some cases even after a predetermined time elapses and the processing is terminated. In a case like this, the processed semiconductor substrate must be handled as a defective product or processed again after the filter is replaced. This decreases the throughput or delays the processing.

The reference concerning the processing of semiconductor substrates is as follows.

Japanese Patent Laid-Open No. 2001-205158

### SUMMARY OF THE INVENTION

According to one aspect of the present invention, there is provided a semiconductor substrate processing apparatus comprising:

a processing bath which etches a semiconductor substrate by dipping the semiconductor substrate into a processing solution;

an outer bath which is positioned outside said processing bath and receives the processing solution overflowing from said processing bath;

a circulation channel which resupplies the processing solution discharged from said outer bath to said processing bath;

a heater which adjusts a temperature of the processing solution flowing through said circulation channel;

a filter which removes foreign matter in the processing solution flowing through said circulation channel; and

a controller which measures, after the semiconductor substrate is loaded into said processing bath, one of the temperature of the processing solution in said processing bath and a time during which the temperature of the processing solution restores a predetermined temperature, calculates a processing time during which the semiconductor substrate is etched on the basis of the measurement result, and etches the semiconductor substrate on the basis of the calculated processing time.

According to one aspect of the present invention, there is provided a semiconductor device fabrication method which etches a semiconductor substrate by using a semiconductor substrate processing apparatus comprising:

a processing bath which etches a semiconductor substrate by dipping the semiconductor substrate into a processing solution;

an outer bath which is positioned outside the processing bath and receives the processing solution overflowing from the processing bath;

a circulation channel which resupplies the processing solution discharged from the outer bath to the processing bath;

a heater which adjusts a temperature of the processing solution flowing through the circulation channel; and

a filter which removes foreign matter in the processing solution flowing through the circulation channel,

said method comprising:

measuring, after the semiconductor substrate is loaded into the processing bath, one of the temperature of the processing solution in the processing bath and a time during which the temperature of the processing solution restores a predetermined temperature;

calculating a processing time during which the semiconductor substrate is etched on the basis of one of the measured temperature and time; and

etching the semiconductor substrate on the basis of the calculated processing time.

### BRIEF DESCRIPTION OF THE DRAWINGS

FIG. 1 is a block diagram showing the arrangement of a semiconductor substrate processing apparatus according to the first embodiment of the present invention;

FIG. 2 is a graph showing the relationship between the temperature of a processing solution in a processing bath and the etching rate;

FIG. 3 is a graph showing the relationship between the temperature of the processing solution in the processing bath and the time after a semiconductor substrate is loaded into the processing bath;

FIG. 4 is a flowchart showing a semiconductor substrate processing sequence according to the first embodiment of the present invention;

FIG. 5 is a graph showing the relationship between the temperature of the processing solution in the processing bath and the time after a semiconductor substrate is loaded into the processing bath;

FIG. 6 is a graph showing the relationship between the insufficient etching amount and the additional time;

FIG. 7 is a flowchart showing the steps of a semiconductor substrate processing method according to the second embodiment of the present invention;

FIG. 8 is a graph showing the relationship between the temperature of the processing solution in the processing bath and the time after a semiconductor substrate is loaded into the processing bath;

FIG. 9 is a flowchart showing the steps of a semiconductor substrate processing method according to the third embodiment of the present invention;

FIG. 10 is a graph showing the relationship between the temperature of the processing solution in the processing bath and the time, for each number of semiconductor substrates loaded.

### DETAILED DESCRIPTION OF THE INVENTION

Embodiments of the present invention will be described below with reference to the accompanying drawings.

### (1) First Embodiment

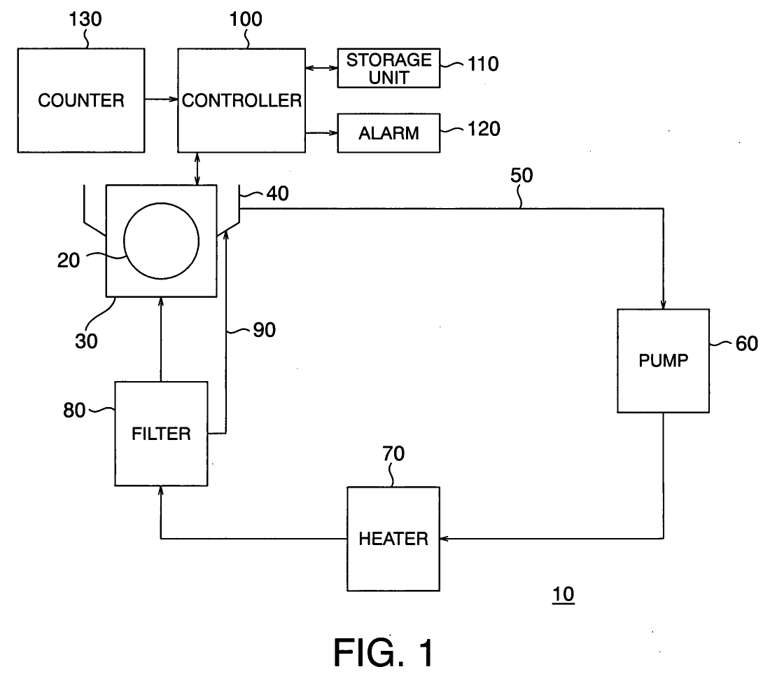

FIG. 1 shows the arrangement of a semiconductor substrate processing apparatus 10 according to the first embodiment of the present invention. The semiconductor substrate processing apparatus 10 etches or cleans a semiconductor substrate 20 by dipping it in a processing solution in a processing bath 30.

Outside the processing bath 30 containing the processing solution, the semiconductor substrate processing apparatus 10 has an outer bath 40 for receiving the processing solution overflowing from the processing bath 30. When discharged from the outer bath 40, the processing solution is resupplied to the processing bath 30 through a circulation channel 50.

The circulation channel 50 has a pump 60 for circulating the processing solution, a heater 70 for adjusting the temperature of the processing solution flowing through the circulation channel 50, and a filter 80 for removing particles (foreign matter) which come off the semiconductor substrate 20 and exist in the processing solution flowing in the circulation channel 50.

The filter 80 is connected to a filter air vent line 90 capable of directly supplying the processing solution to the outer bath 40. If the flow rate of the processing solution supplied to the processing bath 30 decreases owing to clogging of the filter 80, the processing solution is supplied to the outer bath 40 through the filter air vent line 90 at a flow rate corresponding to the decrease.

A thermometer (not shown) is set in the processing bath 30 and measures the temperature of the processing solution contained in the processing bath 30. A controller 100 controls the whole of the semiconductor substrate processing apparatus 10. The controller 100 also monitors the temperature measured by the thermometer set in the processing bath 30.

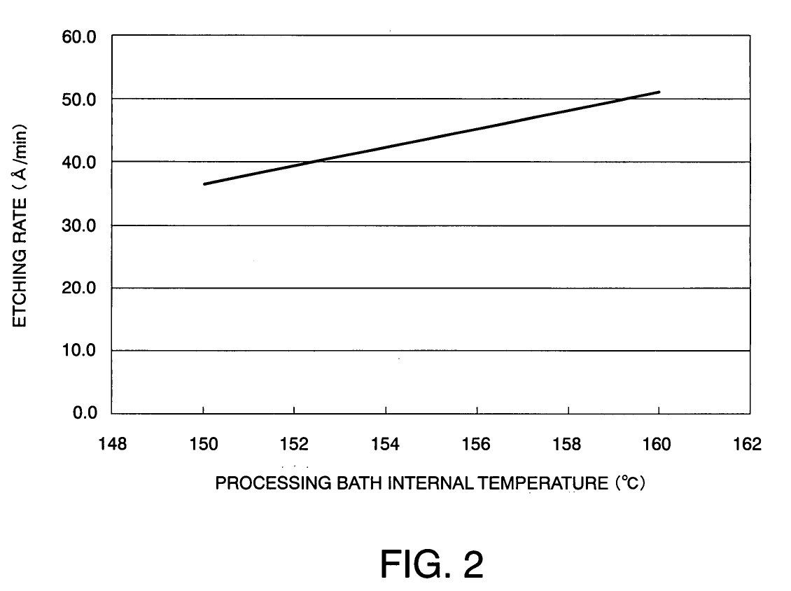

As shown in FIG. 2, the etching rate of the semiconductor substrate 20 depends on the temperature of the processing solution contained in the processing bath 30. That is, when the temperature of the processing solution is low, the etching rate is also low, and, when the temperature of the processing solution is high, the etching rate is also high. Etching data indicating the correspondence of the temperature of the processing solution to the etching rate as described above is prestored in a storage unit 110.

The storage unit 110 also stores data (to be referred to as temperature change data hereinafter) indicating the way the temperature of the processing solution in the processing bath 30 changes with time after the semiconductor substrate 20 is loaded into the processing bath 30 when a predetermined filter, e.g., a new filter is used.

On the basis of the processing solution temperature measured by the thermometer and the temperature change data and etching data stored in the storage unit 110, the controller 100 calculates a processing time necessary to etch the semiconductor substrate 20. After this processing time elapses, the controller 100 terminates the etching process by the semiconductor substrate processing apparatus 10.

Also, if the controller 100 determines that the calculated processing time will exceed a predetermined upper limit, it activates an alarm 120 to notify the operator that the filter 80 must be replaced. Note that a counter 130 counts the number of semiconductor substrates 20 loaded into the processing bath 30, and notifies the controller 100 of the number.

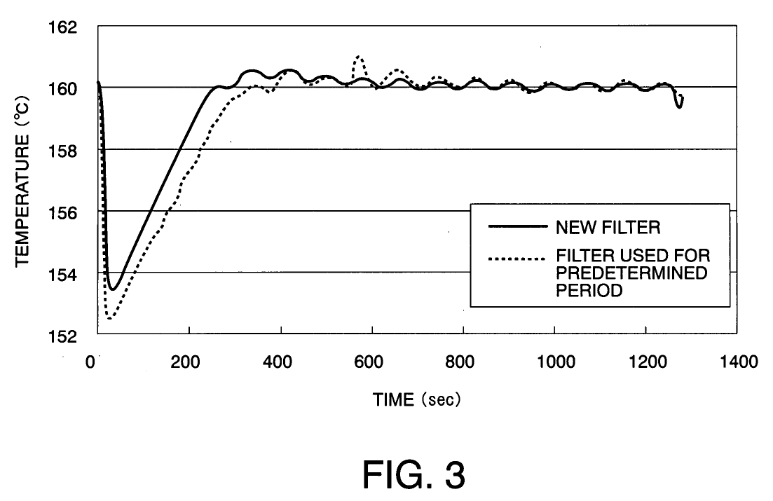

FIG. 3 shows temperature change data of the processing solution after semiconductor substrates 20 are loaded into the processing bath 30. As shown in FIG. 3, immediately after semiconductor substrates 20 are loaded into the processing bath 30, the temperature of the processing solution largely falls under the influence of the semiconductor substrates 20. This fall of the temperature of the processing solution decreases the etching rate. Therefore, the temperature of the processing solution is restored to a predetermined temperature by turning on the heater 7, thereby restoring the original etching rate.

When the same filter 80 is kept used for a predetermined period, it clogs by capturing particles. Consequently, the flow rate of the processing solution supplied from the filter 80 to the processing bath 30 decreases, and the flow rate of the processing solution supplied to the outer bath 40 through the filter air vent line 90 increases.

If semiconductor substrates 20 are loaded into the processing bath 30 in this state, the temperature of the processing solution falls more than when a new filter 80 is used. In addition, even after the heater 70 is turned on, the restoration of the temperature of the processing solution is somewhat moderate. This prolongs the restoration time of the temperature of the processing solution.

In the semiconductor substrate processing apparatus 10 of this embodiment, therefore, a processing time required to etch the semiconductor substrates 20 when a predetermined filter, e.g., a new filter is used is corrected in accordance with the state of the filter 80 actually used, thereby etching the semiconductor substrates 20 until the corrected processing time elapses.

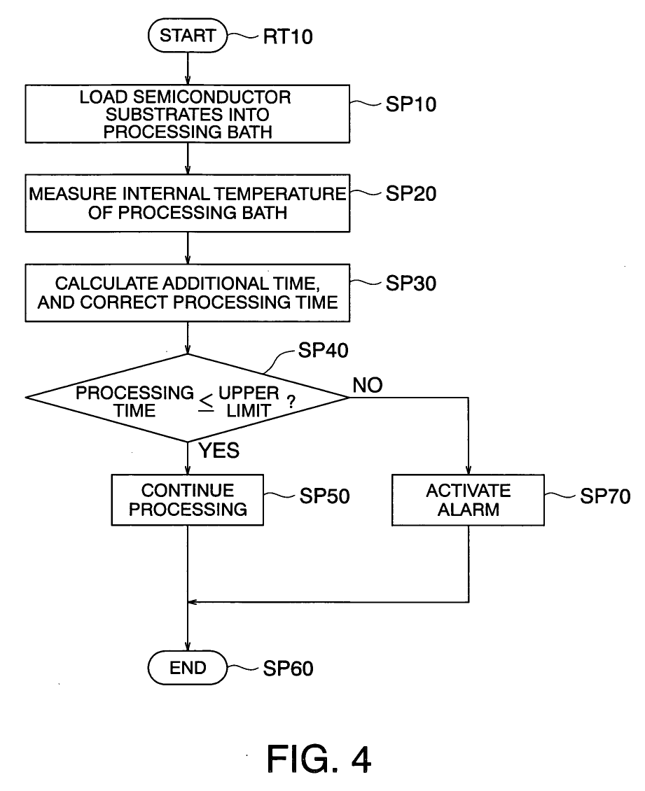

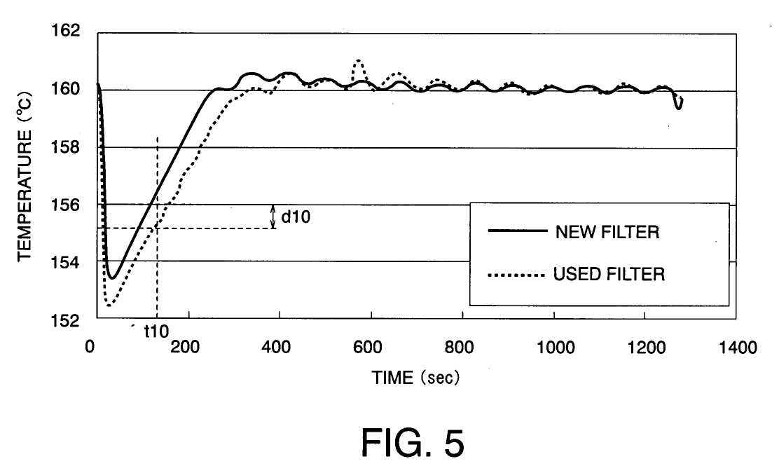

FIG. 4 shows semiconductor substrate processing sequence RT10 according to this embodiment. FIG. 5 shows the temperature change data of the processing solution in the processing bath 30 after semiconductor substrates 20 are loaded into the processing bath 30, for each of a new filter and a filter currently being used. When semiconductor substrate processing sequence R10 starts in FIG. 4, semiconductor substrates 20 are loaded into the processing bath 30 in step SP10. Subsequently, in step SP20, the controller 100 measures the temperature of the processing solution in the processing bath 30 at time t10.

In step SP30, the controller 100 reads out, from the storage unit 110, the temperature of the processing solution in the processing bath 30 at time t10 when a new filter is used, and calculates a temperature difference d10 between the readout temperature and the temperature of the processing solution in the processing bath 30 currently being used.

Assuming that the slope when the temperature of the processing solution in the processing bath 30 currently being used restores is the same as the slope when the temperature of the processing solution in the processing bath 30 restores when a new filter is used, the controller 100 calculates, on the basis of the calculated temperature difference d10, temperature change data of the processing solution in the processing bath 30 currently being used.

Then, the controller 100 reads out, from the storage unit 110, the etching data indicating the correspondence of the temperature of the processing solution to the etching rate. On the basis of this etching data and the temperature change data of the processing solution in the processing bath 30 currently being used, the controller 100 calculates data (to be referred to as etching rate change data hereinafter) indicating the way the etching rate of the processing solution in the processing bath 30 currently being used changes with time.

In addition, the controller 100 reads out, from the storage unit 110, the temperature change data of the processing solution in the processing bath 30 when a new filter is used. On the basis of the readout temperature change data and the etching data described above, the controller 100 calculates etching rate change data of the processing solution in the processing bath 30 when a new filter is used.

The controller 100 integrates this etching rate change data of the processing solution in the processing bath 30 when a new filter is used by a predetermined processing time required for etching, thereby calculating an etching amount required to complete etching.

At the same time, the controller 100 integrates the etching rate change data of the processing solution in the processing bath 30 currently being used by the same time as the processing time described above, thereby estimating an etching amount when the processing time elapses.

The controller 100 calculates the difference between the etching amount necessary to complete etching and the estimated etching amount when the processing time elapses, thereby calculating an etching amount to be insufficient (to be referred to as an insufficient etching amount hereinafter).

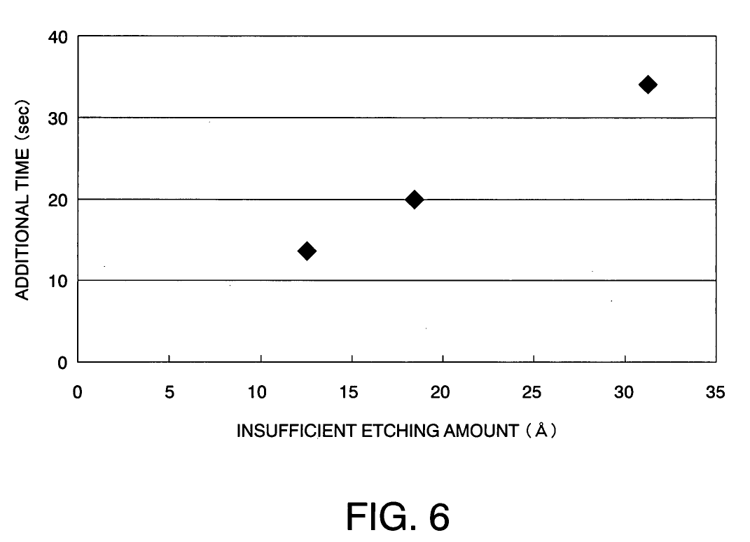

As shown in FIG. 6, an additional time which is produced, with respect to the processing time required for etching when a new filter used, when the temperature of the processing solution in the processing bath 30 falls depends on the insufficient etching time. For example, when the insufficient etching amount is small, the additional time is short, and, when the insufficient etching amount is large, the additional time is long. Additional time data indicating the correspondence of the insufficient etching time to the additional time is prestored in the storage unit 110.

The controller 100 calculates an additional time corresponding to the insufficient etching time on the basis of this additional time data, and corrects the processing time by adding the calculated additional time to it.

Note that when phosphoric acid (H₃PO₄) is used as the processing solution to etch a silicon nitride film (SiN) by 100 nm at a temperature of 160° C., the processing time is 1,000 sec if a new filter is used. On the other hand, if the filter 80 which has been used for a predetermined period is used, the additional time is 30 sec when temperature difference d10 is 1.3° C., and 21 sec when it is 1.0° C., when 90 sec elapse after semiconductor substrates 20 are loaded.

In step SP40, the controller 100 checks whether the corrected processing time is equal to or smaller than a predetermined upper limit. If YES in step SP40, this indicates that no clogging occurs basically in the filter 80. If there is clogging to an extent that temperature control of the process is not affected, the controller 100 judges YES. Controller 100 advances to step SP50 to continue the etching process, and then advances to step SP60 to terminate processing sequence RT10.

On the other hand, if NO in step SP40, this indicates that the filter 80 is beginning to clog, so the controller 100 advances to step SP70 to activate the alarm 120 to notify the operator that the filter 80 requires replacement, while performing the etching process. After the etching process is completed, the operator replaces or cleans the filter 80. The flow then advances to step SP60 to terminate processing sequence RT10.

In this embodiment as described above, etching can be reliably performed by correcting the etching time of the semiconductor substrate 20 in accordance with the fall of the internal temperature of the processing bath 30, which is caused by clogging of the filter 80. Accordingly, the yield can be increased.

If clogging of the filter 80 worsens and the amount of processing solution flowing through the filter air vent line 90 increases, it is sometimes impossible to adjust and restore the temperature of the processing solution in the processing bath 30. In this case, the processed semiconductor substrate must be handled as a defective product or processed again after the filter is replaced.

In this embodiment, therefore, the upper limit of the processing time is selected within the range in which the temperature of the processing solution in the processing bath 30 can be adjusted. If the corrected processing time exceeds this upper limit, the operator is notified and promoted to replace or clean the filter 80. In this manner, it is possible to avoid an event in which clogging of the filter 80 worsens to make the adjustment of the temperature of the processing solution in the processing bath 30 impossible.

### (2) Second Embodiment

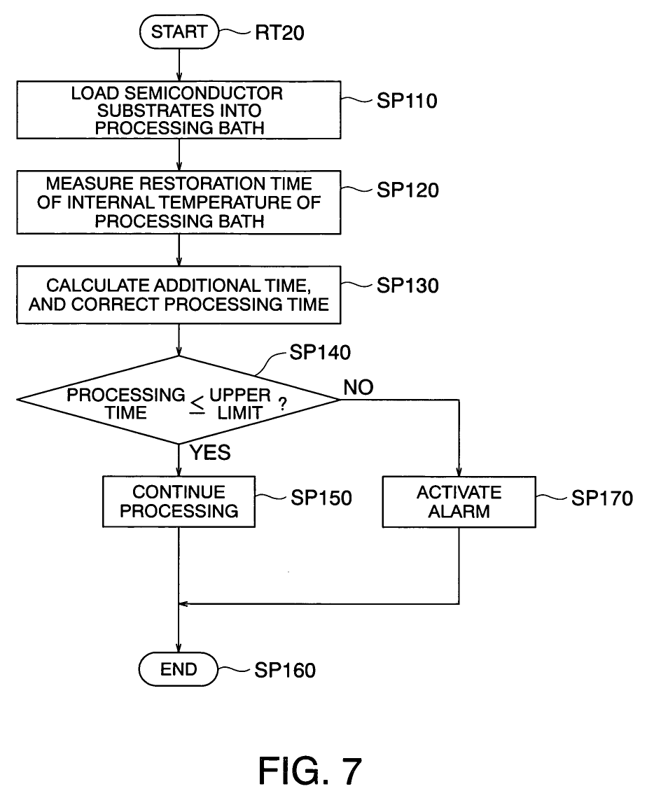

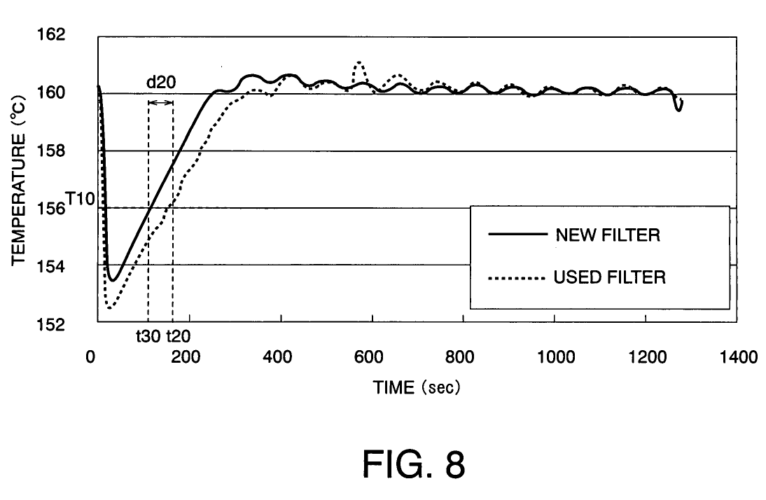

FIG. 7 shows semiconductor substrate processing sequence RT20 according to the second embodiment. FIG. 8 shows temperature change data of a processing solution in a processing bath 30 after semiconductor substrates 20 are loaded into the processing bath 30, for each of a predetermined filter, e.g., a new filter and a filter currently being used. When semiconductor substrate processing sequence RT20 starts in FIG. 7, semiconductor substrates 20 are loaded into the processing bath 30 in step SP110. Subsequently, in step SP120, a controller 100 measures time t20 at which the temperature of the processing solution in the processing bath 30 restores to T10.

In step SP130, the controller 100 reads out, from a storage unit 110, time t30 at which the temperature of the processing solution in the processing bath 30 restores to T10 when a new filter is used, and calculates a time difference d20 between readout time t30 and time t20 at which the temperature of the processing solution in the processing bath 30 currently being used restores to T10.

Then, assuming that the slope when the temperature of the processing solution in the processing bath 30 currently being used is the same as the slope when the temperature of the processing solution in the processing bath 30 restores when a new filter is used, the controller 100 calculates, on the basis of the calculated time difference d20, temperature change data of the processing solution in the processing bath 30 currently being used.

After that, in the same manner as in the first embodiment, the controller 100 calculates an additional time, corrects the processing time, and checks in step SP140 whether the corrected processing time is equal to or smaller than a predetermined upper limit.

If YES in step SP140, the controller 100 advances to step SP150 to continue the etching process, and then advances to step SP160 to terminate processing sequence RT20.

On the other hand, if NO in step SP140, the controller 100 advances to step SP170 to activate an alarm 120 while performing the etching process, thereby notifying the operator that a filter 80 requires replacement. After that, the controller 100 advances to step SP160 to terminate processing sequence RT20.

In this embodiment as described above, etching can be reliably performed by correcting the etching time of the semiconductor substrate 20 on the basis of the increase in restoration time of the internal temperature of the processing bath 30, which is caused by clogging of the filter 80. Accordingly, the yield can be increased.

### (3) Third Embodiment

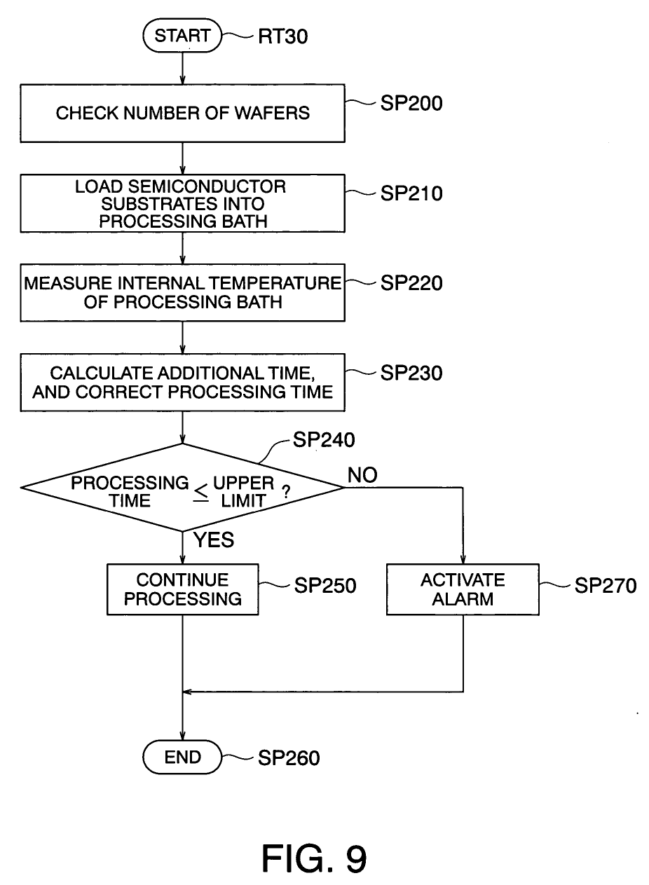

FIG. 9 shows semiconductor substrate processing sequence RT30 according to the third embodiment. When semiconductor substrate processing sequence RT30 starts in FIG. 9, in step SP200, a counter 130 counts the number of semiconductor substrates 20 to be loaded into a processing bath 30, and notifies a controller 100 of the number. In step SP210, the semiconductor substrates 20 are loaded into the processing bath 30. In step SP220, the controller 100 measures the temperature of a processing solution in the processing bath 30 at a predetermined timing.

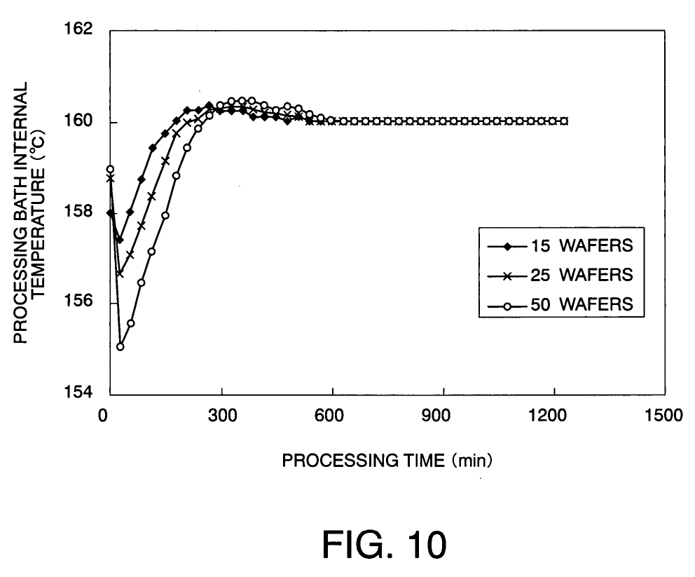

The degree of the temperature fall of the processing solution in the processing bath 30 after semiconductor substrates 20 are loaded into the processing bath 30 changes in accordance with the number of the semiconductor substrates 20 loaded. That is, as shown in FIG. 10, as the number of semiconductor substrates 20 loaded increases, the degree of the fall of the temperature of the processing solution in the processing bath 30 increases. For example, the temperature falls by about 4° C. when the number of semiconductor substrates 20 loaded is 50.

In this embodiment, therefore, a storage unit 110 prestores temperature change data of the processing solution in the processing bath 30 after semiconductor substrates 20 are loaded when a predetermined filter, e.g., a new filter is used, for each number of semiconductor substrates 20 loaded.

In step SP230, the controller 100 reads out, from the storage unit 110, temperature change data corresponding to the number of the semiconductor substrates 20 loaded, and calculates a temperature difference, at the predetermined timing, between the temperature of the processing solution in the processing bath 30 when a new filter is used and the temperature of the processing solution in the processing bath 30 currently being used.

In this case, the controller 100 may also calculate a time difference between the time before the temperature of the processing solution in the processing bath 30 currently being used restores a predetermined temperature and the time before the temperature of the processing solution in the processing bath 30 restores the predetermined temperature when a new filter is used.

After that, in the same manner as in the first embodiment, the controller 100 calculates an additional time, corrects the processing time, and advances to step SP240 to check whether the corrected processing time is equal to or smaller than a predetermined upper limit. Then, the controller 100 performs a processing corresponding to the determination result in step SP250 or SP270, and advances to step SP260 to terminate processing sequence RT30.

In this embodiment as described above, etching can be reliably performed by correcting the etching time of semiconductor substrates 20 in accordance with the fall of the temperature of the processing solution in the processing bath 30, which is caused by clogging of a filter 80 and by the number of the semiconductor substrates 20 loaded. Accordingly, the yield can be increased.

The semiconductor substrate processing apparatuses and semiconductor device fabrication methods of the above embodiments can reliably perform etching and increase the yield.

### (4) Other Embodiments

Note that the above embodiments are merely examples and do not limit the present invention. For example, the temperature change data is calculated by assuming that the slope when the temperature of the processing solution in the processing bath 30 currently being used restores is the same as the slope when the temperature of the processing solution in the processing bath 30 restores when a new filter is used. However, it is also possible to assume that these two slopes are different. In this case, the temperature change data of the processing solution in the processing bath 30 currently being used can be calculated by calculating temperature differences at two different timings.

Also, if the temperature of the processing solution in the processing bath 30 does not largely fall immediately after semiconductor substrates 20 are loaded into the processing bath 30, and the slope at which the temperature of the processing solution in the processing bath 30 currently being used restores is not linear but rises and falls little by little, the temperature change data of the processing solution in the processing bath 30 currently being used can be calculated by calculating temperature differences at three or more different timings.

What is claimed is:

1. A semiconductor substrate processing apparatus comprising:
a processing bath which etches a semiconductor substrate by dipping the semiconductor substrate into a processing solution;
an outer bath which is positioned outside said processing bath and receives the processing solution overflowing from said processing bath;
a circulation channel which resupplies the processing solution discharged from said outer bath to said processing bath;
a heater which adjusts a temperature of the processing solution flowing through said circulation channel;
a filter which removes foreign matter in the processing solution flowing through said circulation channel; and
a controller which measures, after the semiconductor substrate is loaded into said processing bath, one of the temperature of the processing solution in said processing bath and a time during which the temperature of the processing solution restores a predetermined temperature, calculates a processing time during which the semiconductor substrate is etched on the basis of the measurement result, and etches the semiconductor substrate on the basis of the calculated processing time.

2. An apparatus according to claim 1, further comprising a counter which counts the number of semiconductor substrates loaded into said processing bath,
wherein said controller calculates the processing time on the basis of the number of the semiconductor substrates and one of the temperature and time measured, and etches the semiconductor substrates on the basis of the calculated processing time.

3. An apparatus according to claim 1, wherein said controller measures the temperature of the processing solution in the processing bath at a predetermined timing after the semiconductor substrate is loaded into said processing bath, calculates a temperature difference, at the predetermined timing, between the measured temperature and the temperature of the processing solution in said processing bath when a predetermined filter is used, calculates a processing time during which the semiconductor substrate is etched on the basis of the temperature difference, and etches the semiconductor substrate on the basis of the calculated processing time.

4. An apparatus according to claim 3, further comprising a counter which counts the number of semiconductor substrates loaded into said processing bath,
wherein said controller calculates the processing time on the basis of the number of the semiconductor substrates and the temperature difference, and etches the semiconductor substrates on the basis of the calculated processing time.

5. An apparatus according to claim 1, wherein said controller measures a time during which the temperature of the processing solution in said processing bath restores a predetermined temperature after the semiconductor substrate is loaded into said processing bath, calculates a time difference between the measured time and a time during which the temperature of the processing solution in said processing bath restores the predetermined temperature when a predetermined filter is used, calculates a processing time during which the semiconductor substrate is etched on the basis of the time difference, and etches the semiconductor substrate on the basis of the calculated processing time.

6. An apparatus according to claim 5, further comprising a counter which counts the number of semiconductor substrates loaded into said processing bath,
wherein said controller calculates the processing time on the basis of the number of the semiconductor substrates and the time difference, and etches the semiconductor substrates on the basis of the calculated processing time.

7. An apparatus according to claim 1, further comprising a storage unit which prestores etching data representing a correspondence of the temperature of the processing solution in said processing bath to an etching rate,
wherein said controller calculates the processing time by estimating an etching amount of the semiconductor substrate on the basis of the etching data and one of the temperature and time, and etches the semiconductor substrate on the basis of the calculated processing time.

8. An apparatus according to claim 3, further comprising a storage unit which prestores etching data representing a correspondence of the temperature of the processing solution in said processing bath to an etching rate,
wherein said controller calculates the processing time by estimating an etching amount of the semiconductor substrate on the basis of the etching data and the temperature difference, and etches the semiconductor substrate on the basis of the calculated processing time.

9. An apparatus according to claim 5, further comprising a storage unit which prestores etching data representing a correspondence of the temperature of the processing solution in said processing bath to an etching rate,
wherein said controller calculates the processing time by estimating an etching amount of the semiconductor substrates on the basis of the etching data and the time difference, and etches the semiconductor substrates on the basis of the calculated processing time.

10. A semiconductor device fabrication method which etches a semiconductor substrate by using a semiconductor substrate processing apparatus comprising:
a processing bath which etches a semiconductor substrate by dipping the semiconductor substrate into a processing solution;
an outer bath which is positioned outside the processing bath and receives the processing solution overflowing from the processing bath;
a circulation channel which resupplies the processing solution discharged from the outer bath to the processing bath;
a heater which adjusts a temperature of the processing solution flowing through the circulation channel; and
a filter which removes foreign matter in the processing solution flowing through the circulation channel,
said method comprising:
measuring, after the semiconductor substrate is loaded into the processing bath, one of the temperature of the processing solution in the processing bath and a time during which the temperature of the processing solution restores a predetermined temperature;
calculating a processing time during which the semiconductor substrate is etched on the basis of one of the measured temperature and time; and
etching the semiconductor substrate on the basis of the calculated processing time.

11. A method according to claim 10, further comprising, counting the number of semiconductor substrates loaded into the processing bath,
wherein when the processing time is calculated, the processing time is calculated on the basis of the number of the semiconductor substrates and one of the temperature and time.

12. A method according to claim 10, wherein
when the temperature of the processing solution is measured, the temperature of the processing solution in the processing bath is measured at a predetermined timing after the semiconductor substrate is loaded into the processing bath, and
when the processing time during which the semiconductor substrate is etched is calculated, a temperature difference, at the predetermined timing, between the temperature of the processing solution in the processing bath when a predetermined filter is used and the measured temperature is calculated, and a processing time during which the semiconductor substrate is etched is calculated on the basis of the temperature difference.

13. A method according to claim 12, further comprising, counting the number of semiconductor substrates loaded into the processing bath,
wherein when the processing time is calculated, the processing time is calculated on the basis of the number of the semiconductor substrates and the temperature difference.

14. A method according to claim 10, wherein
when the temperature of the processing solution is measured, a time during which the temperature of the processing solution in the processing bath restores a predetermined temperature after the semiconductor substrate is loaded into the processing bath is measured, and
when the processing time during which the semiconductor substrate is etched is calculated, a time difference between the measured time and a time during which the temperature of the processing solution in the processing bath restores the predetermined temperature when a predetermined filter is used is calculated, and a processing time during which the semiconductor substrate is etched is calculated on the basis of the time difference.

15. A method according to claim 12, further comprising, counting the number of semiconductor substrates loaded into the processing bath,
wherein when the processing time during which the semiconductor substrate is etched is calculated, the processing time is calculated on the basis of the number of the semiconductor substrates and the time difference, and the semiconductor substrates are etched on the basis of the calculated processing time.

16. A method according to claim 10, further comprising, prestoring etching data representing a correspondence of the temperature of the processing solution in the processing bath to an etching rate,
wherein the processing time is calculated, the processing time is calculated by estimating an etching amount of the semiconductor substrate on the basis of the etching data and one of the temperature and time.

17. A method according to claim 12, further comprising, prestoring etching data representing a correspondence of the temperature of the processing solution in the processing bath to an etching rate,
wherein the processing time is calculated, the processing time is calculated by estimating an etching amount of the semiconductor substrate on the basis of the etching data and the temperature difference.

18. A method according to claim 14, further comprising, prestoring etching data representing a correspondence of the temperature of the processing solution in the processing bath to an etching rate,
wherein the processing time is calculated, the processing time is calculated by estimating an etching amount of the semiconductor substrate on the basis of the etching data and the time difference.
